(19) United States
(12) Patent Application Publication
(10) Pub. No.: US 2024/0311929 A1
(43) Pub. Date: Sep. 19, 2024

(54) UTILIZING DIGITAL FILES ASSOCIATED WITH NON-FUNGIBLE TOKENS TO PROVIDE PSYCHOLOGICAL AND EXPERIENCED BASED PROFILE CONNECTIONS

(71) Applicant: Mutually United, Inc., Schwenksville, PA (US)

(72) Inventor: Stephen Geday, Schwenksville, PA (US)

(73) Assignee: Mutually United, Inc., Schwenksville, PA (US)

(21) Appl. No.: 18/184,371

(22) Filed: Mar. 15, 2023

Related U.S. Application Data
(60) Provisional application No. 63/319,958, filed on Mar. 15, 2022.

(51) Int. Cl. G06Q 50/00; G06Q 30/018

(52) U.S. Cl. CPC G06Q 50/01; G06Q 30/0185

(57) ABSTRACT

A method is provided. The is implemented by a software platform and interface executed by processors. The method includes analyzing digital files of user profiles and a current user profile to generate proximity data, affinity data, or authenticity data. The method includes determining matches between the user profiles and the current user profile based on the proximity data, the affinity data, or the authenticity data. The method includes presenting a user interface in accordance with the matches or the proximity data, affinity data, or authenticity data.

### CROSS REFERENCE TO RELATED APPLICATIONS

This application claims priority from U.S. Patent Application No. 63/319,958, entitled “UTILIZING DIGITAL FILES ASSOCIATED WITH NON-FUNGIBLE TOKENS TO PROVIDE PSYCHOLOGICAL AND EXPERIENCED BASED PROFILE CONNECTIONS,” filed on Mar. 15, 2022, which is hereby incorporated by reference as if set forth in full in this application for all purposes.

### BACKGROUND

Currently, there are presently no techniques for authentic human connections through social media with respect to non-fungible tokens and psychological and experienced based user information.

### SUMMARY

According to one or more embodiments, a method is provided. The method is implemented by a software platform and interface executed by one or more processors. The method includes analyzing one or more digital files of one or more user profiles and a current user profile to generate proximity data, affinity data, or authenticity data. The method includes determining one or more matches between the one or more user profiles and the current user profile based on the proximity data, the affinity data, or the authenticity data. The method includes presenting a user interface in accordance with the one or more matches or the proximity data, affinity data, or authenticity data.

According to one or more embodiments, a computer program product is provided. The computer program product is stored on a computer readable storage medium and executable by at least one processor. The computer program product includes analyzing one or more digital files of one or more user profiles and a current user profile to generate proximity data, affinity data, or authenticity data. The computer program product includes determining one or more matches between the one or more user profiles and the current user profile based on the proximity data, the affinity data, or the authenticity data. The computer program product includes presenting a user interface in accordance with the one or more matches or the proximity data, affinity data, or authenticity data.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1 illustrates a method according to one or more embodiments;

FIG. 2 illustrates a system according to one or more embodiments;

FIG. 3 illustrates a method according to one or more embodiments;

FIG. 4 illustrates an artificial intelligence system according to one or more exemplary embodiments;

FIG. 5 illustrates a system and a method performed by the system according to one or more embodiments;

FIG. 6 illustrates a diagrams and interfaces according to one or more exemplary embodiments;

FIG. 7 illustrates an interface according to one or more exemplary embodiments;

FIG. 8 illustrates interfaces according to one or more exemplary embodiments; and

FIG. 9 illustrates an interface according to one or more exemplary embodiments.

### DETAILED DESCRIPTION

Disclosed herein is a software platform and interface. According to one or more embodiments, the software platform and interface uses digital files associated with non-fungible tokens (NFTs) to provide psychological and experienced based profile connections. The software platform and interface provides digital tools and social media solutions configured to digitally scale and organically forge high value and meaningful connections between profiles using digital NFT assets. Each profile within the software platform and interface can represent a person and include at least psychological and experienced based user information about that person. Each digital NFT asset includes a digital file, such as a photo, a document, a video, etc., and an associated NFT, which is a non-interchangeable unit of data stored on a digital ledger, such as a blockchain, that is associated with a digital file. NFTs transform digital files into one-of-a-kind, verifiable assets (e.g., digital NFT assets). In this regard, each NFT enables unique identification and, in turn, sole ownership of a particular digital file, which can then be displayed, tracked, sold, and traded. Further, the software platform and interface can extract and analyze proximity, affinity, and/or authenticity data (e.g., the psychological and experienced based user information about that person) from the digital NFT assets with confidence due to the NFTs. Proximity data can include a close physical immediacy by correlating a time and a space of the two profiles (e.g., “here and now”). Affinity data can include likes, values, and comforts shared between the two profiles. Authenticity data can include verified activity and/or assertions by the two profiles. In turn, profile connections can be forged by the software platform and interface by linking two profiles in view of the psychological and experienced based user information to represent a human connection between two people corresponding to those two profiles.

The psychological and experienced based user information is at the root of the human experience and drive high value and meaningful human connections. Thus, the software platform and interface integrates psychological and experienced based user information to infinitely scale human connections for whatever purpose users may find value in. Practical applications of the software platform and interface can include, but is not limited to, being casual observers, forging connections, establishing friendships, dating, and networking. The software platform and interface, including digital tools and social media solutions therein, can be processor executable code or instructions that are necessarily rooted in process operations by, and in processing hardware of, a computing device/system/environment.

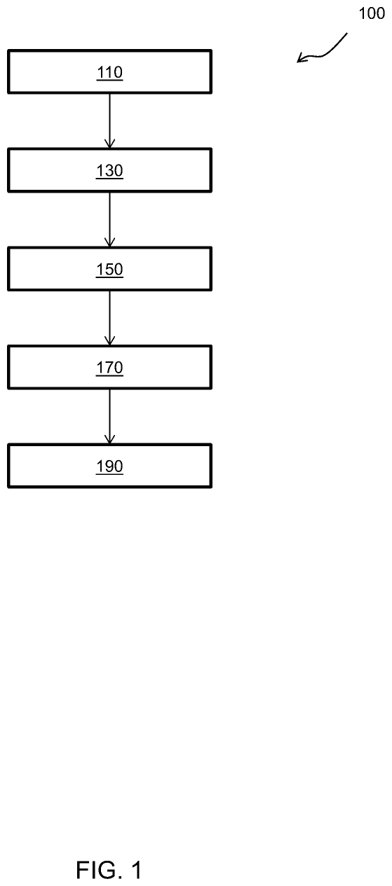

As shown in FIG. 1, an exemplary method 100 of the software platform and interface is illustrated according to one or more embodiments. At block 110, the software platform and interface filters one or more user profiles based on a proximity setting (e.g., proximity setting comprises time and/or space factors) of a current user profile to provide a filtered profile set including one or more filtered profiles. At block 130, the software platform and interface analyzes the one or more filtered profiles of the filtered profile set based on psychological and experienced based user information (e.g., the proximity data, the affinity data, and/or the authenticity data) to determine one or more matches to the current user profile. At block 150, the software platform and interface presents the one or more matches (e.g., suggests high value and meaningful connections between profiles) in a user interface of the software platform and interface. At block 170, the software platform and interface configures one or more profile connections with respect to the one or more matches (e.g., in response to one or more inputs, the one or more profile connections are established to the current user profile). At block 190, the software platform and interface enables heat meter information to be configured for each of the one or more profile connections through the user interface of the software platform. One or more advantages, technical effects, and/or benefits of the software platform and interface can include providing authentic human connections through social media with respect to psychological and experienced based user information.

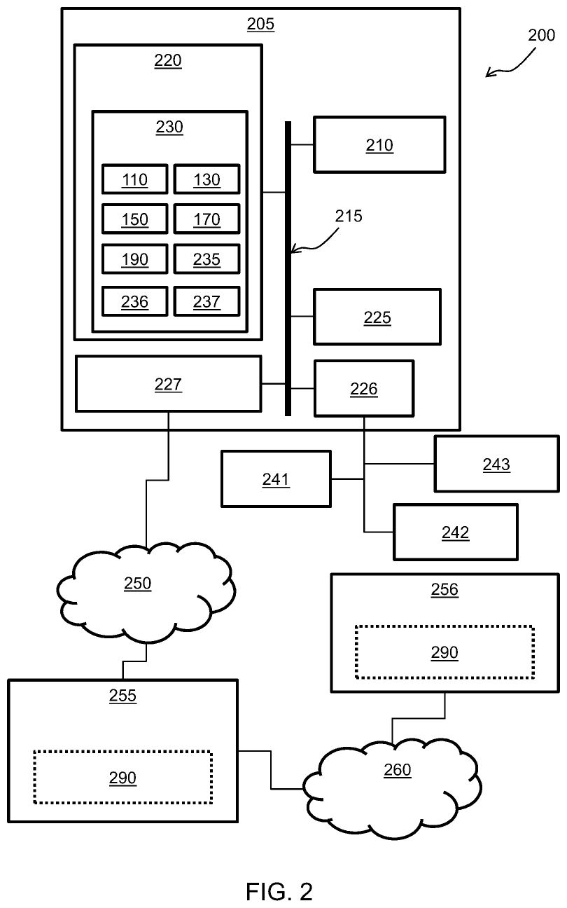

Turning now to FIG. 2, a computing system 200 is illustrated according to one or more embodiments. The computing system 200 can be representative of any computing device, computing apparatus, and/or computing environment, which comprise hardware, software, or a combination thereof. Further, embodiments of the computing system 200 disclosed may include apparatuses, systems, methods, and/or computer program products at any possible technical detail level of integration.

The computing system 200 has a device 205 with one or more central processing units (CPU(s)), which are collectively or generically referred to as a processor 210. The processor 210, also referred to as processing circuits, is coupled via a system bus 215 to a system memory 220 and various other components. The computing system 200 and/or the device 205 may be adapted or configured to perform as an online platform, a server, an embedded computing system, a personal computer, a console, a personal digital assistant (PDA), a cell phone, a tablet computing device, a quantum computing device, cloud computing device, a mobile device, a smartphone, a fixed mobile device, a smart display, a wearable computer, or the like.

The processor 210 may be any type of general or specific purpose processor, including a central processing unit (CPU), application specific integrated circuit (ASIC), field programmable gate array (FPGA), graphics processing unit (GPU), controller, multi-core processing unit, three dimensional processor, quantum computing device, or any combination thereof. The processor 210 may also have multiple processing cores, and at least some of the cores may be configured to perform specific functions. Multi-parallel processing may also be configured. In addition, at least the processor 210 may be a neuromorphic circuit that includes processing elements that mimic biological neurons.

The bus 215 (or other communication mechanism) is configured for communicating information or data to the processor 210, the system memory 220, and various other components, such as the adapters 225, 226, and 227.

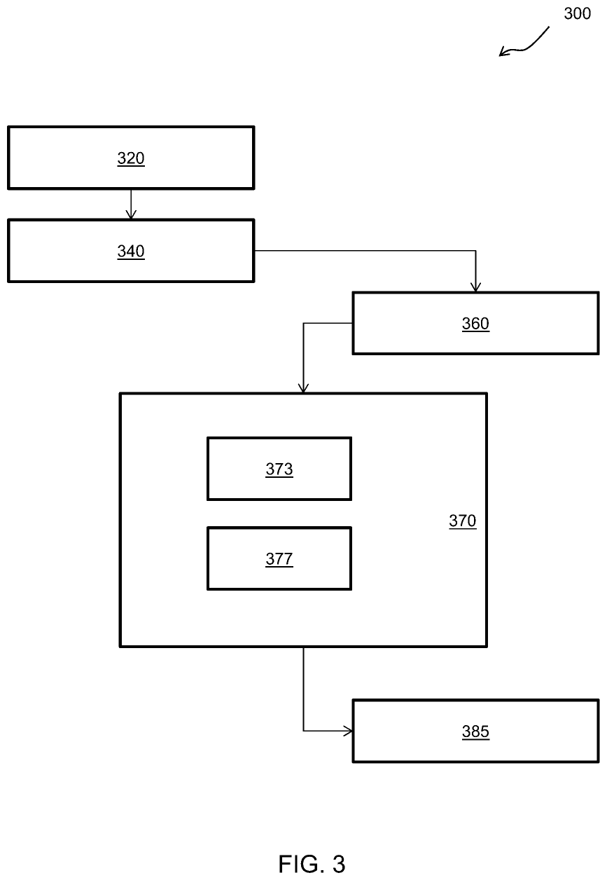

The system memory 220 is an example of a (non-transitory) computer readable storage medium, where software 230 (i.e., the software platform and interface described herein) can be stored as software components, modules, engines, instructions, or the like for execution by the processor 210 to cause the device 205 to operate, such as described herein with reference to FIGS. 1 and 3. The system memory 220 can include any combination of a read only memory (ROM), a random access memory (RAM), internal or external Flash memory, embedded static-RAM (SRAM), solid-state memory, cache, static storage such as a magnetic or optical disk, or any other types of volatile or non-volatile memory. Non-transitory computer readable storage mediums may be any media that can be accessed by the processor 210 and may include volatile media, non-volatile media, or the like. For example, the ROM is coupled to the system bus 215 and may include a basic input/output system (BIOS), which controls certain basic functions of the device 205, and the RAM is read-write memory coupled to the system bus 215 for use by the processors 210. Non-transitory computer readable storage mediums can include any media that is removable, non-removable, or the like.

According to one or more embodiments, the software 230 can be configured in hardware, software, or a hybrid implementation. The software 230 can be composed of modules that are in operative communication with one another, and to pass information or instructions. According to one or more embodiments, the software 230 can provide one or more user interfaces, such as on behalf of the operating system or other application and/or directly as needed. The user interfaces include, but are not limited to, graphic user interfaces, window interfaces, internet browsers, and/or other visual interfaces for applications, operating systems, file folders, and the like. Thus, user activity can include any interaction or manipulation of the user interfaces provided by the software 230. The software 230 can further include custom modules to perform application specific processes or derivatives thereof, such that the computing system 200 may include additional functionality. For example, according to one or more embodiments, the software 230 may be configured to store information, instructions, commands, or data to be executed or processed by the processor 210 to logically implement the method 100 of FIG. 1 (as represented by block 110, 130, 150, 170, and 190 within the software 230). Further, the software 230 may be configured to store information, instructions, commands, or data to be executed or processed by the processor 210 to logically implement the method 300 of FIG. 3 (as represented by block 235 within the software 230), with respect to one or more digital files 236 and digital NFT assets 237 (i.e., a digital file 236 associated with an NFT is a digital NFT asset 237). The software 230 of FIG. 2 can also be representative of an operating system, a mobile application, a client application, and/or the like for the device 205 for the computing system 200.

According to one or more embodiments, the software 230 enables people to connect and socialize based on various grounds and for various reasons. As discussed herein, the various grounds and various reasons are qualified by proximity, affinity, and authenticity, as well as immediacy, to foster initial and enhanced interactions and the establishment and growth of relationships. That is, because people are more likely to notice, be drawn to, establish an initial basis other when they are (physically) close and then pursue that connection, the software 230 greatly aids the connection process and provides content for any initial curiosity to occur. Further, the software 230 can support a person reasoning to establish a connection is some type of known and share affinity. In other words, when parties are aware that they have something in common, they are more likely to be noticed, intrigued, drawn to each other and more likely to talk or act to establish a connection. The technical effect and benefit of the software 230 includes solving the concern that people in close proximity with each other have absolutely no idea about the other people in their vicinity.

Further, modules of the software 230 can be implemented as a hardware circuit comprising custom very large scale integration (VLSI) circuits or gate arrays, off-the-shelf semiconductors such as logic chips, transistors, or other discrete components, in programmable hardware devices (e.g., field programmable gate arrays, programmable array logic, programmable logic devices), graphics processing units, or the like. Modules of the software 230 can be at least partially implemented in software for execution by various types of processors. According to one or more embodiments, an identified unit of executable code may include one or more physical or logical blocks of computer instructions that may, for instance, be organized as an object, procedure, routine, subroutine, or function. Executables of an identified module co-located or stored in different locations such that, when joined logically together, comprise the module. A module of executable code may be a single instruction, one or more data structures, one or more data sets, a plurality of instructions, or the like distributed over several different code segments, among different programs, across several memory devices, or the like. Operational or functional data may be identified and illustrated herein within modules of the software 230, and may be embodied in a suitable form and organized within any suitable type of data structure.

Furthermore, modules of the software 230 can also include, but are not limited to, location modules, augmented reality modules, virtual reality modules, blockchain module, and machine learning and/or an artificial intelligence (ML/AI) algorithm modules.

A location module can be configured can be configured to create, build, store, and provide algorithms and models that determine a location of the device 205 and relative distances of other devices comprising user profiles. According to more or more embodiments, the location module can implement location, geosocial networking, spatial navigation, satellite orientation, surveying, distance, direction, and/or time software.

An augmented reality module can be configured to create, build, store, and provide algorithms and models that provide interactive experiences of a real-world environments where objects that reside in the real world are enhanced by computer-generated perceptual information, sometimes across multiple sensory modalities. A virtual reality module can be configured to create, build, store, and provide algorithms and models that simulate experiences similar to or completely different from the real world. According to more or more embodiments, the virtual reality and/or the augmented reality modules can provide augmented, mixed, immersive, and/or text-based virtual reality.

A blockchain module can be configured to create, build, store, and provide algorithms and models that provide records or blocks linked together using cryptography, such that each block contains at least one or more of a cryptographic hash of the previous block (e.g., thereby forming a chain), a timestamp, and transaction data (e.g., social data, connection data, preference data, etc.). The timestamp can identify that the transaction data existed when the block was published to get into its hash. According to one or more, the blockchain module can be a dynamic/evolving user-fed algorithmic implementation (i.e., non-static, administrator-prescriptive viewing/interest algorithm) where users provide activity and preferences (or any inputs described herein). In this regard, user activity and preferences dictate operations of the blockchain module. Additionally, the blockchain module can weight and allocate one or more of the activity and preferences in conjunction with any of the other modules described herein. According to one or more embodiments, the blockchain module of the software 230 can integrate with the one or more digital files 236 and the one or more digital NFT assets 237 of the blockchain to extract and analyze proximity, affinity, and/or authenticity data therefrom. The blockchain module of the software 230 can manage and edit the blockchain so that the digital NFT assets 237 can be provides with the digital files 236 in a virtual scrapbook or other NFT wallet. The blockchain module of the software 230 also provide a marketplace to enable users to not only post the digital NFT assets 237 (in music, sports, entertainment, anime, etc.), but to also purchase, share, trade, and sell the digital NFT assets 237. Note that because each NFT (i.e., token) is uniquely identifiable, the digital NFT assets 237 differ from blockchain cryptocurrencies. The blockchain module of the software 230 also provide a crypto wallet and/or integrate with blockchain cryptocurrencies

A ML/AI algorithm module can be configured to create, build, store, and provide algorithms and models that improve automatically through experience, as well as emulate ‘natural’ cognitive abilities of humans. In an example, machine learning software uses training data to build a particular model and to improve that model, while artificial intelligence software perceives an environment (e.g., receives active data) and takes actions (e.g., applies a model) to solve a problem and/or produce an output. Artificial intelligence software can use a model built by humans and/or machine learning software. Artificial intelligence software can further provide feedback to the machine learning software to improve any models thereof. Machine learning and artificial intelligence can exist independently and/or coexist.

According to one or more embodiments, the software 230 can also include and/or implement a pinwheel interface of users (including a nearby mode), personal interests and automatic matching thereof, bold and shy introductions and automatic matching thereof, chat and video integration with other features of the software 230, friend connections and integration with other features of the software 230, heat meter and automatic matching thereof, and unlocking personal interests and inner thoughts. According to one or more embodiments, the software 230 can provide dynamic/organic/constant feedback, where profiles are adaptively presented based on the viewer. According to one or more embodiments, the software 230 can provide a viewing field, such as a map view of concentration of users, a digital version of pub crawl, and/or an integration of a map. According to one or more embodiments, the software 230 can provide commercial to connecting establishments and/or professional accounts to provide a particular status. As described herein, the software 230 can provide integrate ML/AI, with respect to search terms, learning what user likes, looping inputs, extract interest based information, etc.

With respect to the adapters 225, 226, and 227 of FIG. 2, the device 205 can particularly include an input/output (I/O) adapter 225, a device adapter 226, and a communications adapter 227. According to one or more embodiments, the I/O adapter 225 can be configured as a small computer system interface (SCSI), of in view of frequency division multiple access (FDMA) single carrier FDMA (SC-FDMA), time division multiple access (TDMA), code division multiple access (CDMA), orthogonal frequency-division multiplexing (OFDM), orthogonal frequency-division multiple access (OFDMA), global system for mobile (GSM) communications, general packet radio service (GPRS), universal mobile telecommunications system (UMTS), cdma2000, wideband CDMA (W-CDMA), high-speed downlink packet access (HSDPA), high-speed uplink packet access (HSUPA), high-speed packet access (HSPA), long term evolution (LTE), LTE Advanced (LTE-A), 802.11x, Wi-Fi, Zigbee, Ultra-WideBand (UWB), 802.16x, 802.15, home Node-B (HnB), Bluetooth, radio frequency identification (RFID), infrared data association (IrDA), near-field communications (NFC), fifth generation (5G), new radio (NR), or any other wireless or wired device/transceiver for communication. The device adapter 226 interconnects input/output devices to the system bus 215, such as a display 241, a keyboard 242, a control device 243, or the like (e.g., a camera, a speaker, etc.).

The communications adapter 226 interconnects the system bus 215 with a network 250, which may be an outside network, enabling the device 205 to communicate data with other such devices (e.g., such as the local computing device 255 and, further, the remote computing system 256 through the network 260). In one embodiment, the adapters 225, 226, and 227 may be connected to one or more I/O buses that are connected to the system bus 215 via an intermediate bus bridge. Suitable I/O buses for connecting peripheral devices such as hard disk controllers, network adapters, and graphics adapters typically include common protocols, such as the Peripheral Component Interconnect (PCI).

The display 241 is configured to provide one or more UIs or graphic UIs (GUIs) that can be captured by and analyzes by the software 230, as the users interacts with the device 205. Examples of the display 241 can include, but are not limited to, a plasma, a liquid crystal display (LCD), a light emitting diode (LED), a field emission display (FED), an organic light emitting diode (OLED) display, a flexible OLED display, a flexible substrate display, a projection display, a 4K display, a high definition (HD) display, a Retina@ display, an in-plane switching (IPS) display or the like. The display 241 may be configured as a touch, three dimensional (3D) touch, multi-input touch, or multi-touch display using resistive, capacitive, surface-acoustic wave (SAW) capacitive, infrared, optical imaging, dispersive signal technology, acoustic pulse recognition, frustrated total internal reflection, or the like as understood by one of ordinary skill in the art for input/output (I/O).

The keyboard 242 and the control device 243, such as a computer mouse, a touchpad, a touch screen, a keypad, or the like, may be further coupled to the system bus 215 for input to the device 205. In addition, one or more inputs may be provided to the computing system 200 remotely via another computing system (e.g., the local computing device 255 and/or the remote computing system 256) in communication therewith, or the device 205 may operate autonomously.

According to one or more embodiments, the functionality of the device 205 with respect to the software 230 can also be implemented on the local computing device 255 and/or the remote computing system 256, as represented by separate instances of the recommendation engine 290. Note that the one or more images (e.g., screenshots) can be stored in a common repository located at the device 205, the local computing device 255, and/or the remote computing system 256 and can be downloaded (on demand) to and/or from each of the device 205, the local computing device 255, and/or the remote computing system 256.

Turning now to FIG. 3, a method 300 (e.g., performed by the software 230 of FIG. 2) is illustrated according to one or more exemplary embodiments. The method 300 addresses a need to make authentic human connections through social media with respect to psychological and experienced based user information by providing a multi-step manipulation of at least digital files associated with NFTs (e.g., digital NFT assets 237) that digitally scales and organically forges high value and meaningful connections between profiles (e.g., profile connections).

The method 300 begins at block 320, where the software 290 implemented on the local computing device 255 and/or the remote computing system 256 provide backend/server services to a plurality of devices 205 executing software 230. In this regard, any operations of the software 230 can be offloaded to the software 290 and vice versa. The backend/server services can at least include the operations describe herein with respect to the location modules, augmented reality modules, virtual reality modules, blockchain module, and (ML/AI) algorithm modules.

At block 340, the software 230 provides a user interface, such as for client services (e.g., a mobile application). At block 360, the software 230 enables the creation of a current profile representing a user who owns the device 205. According to one or more embodiments, the software 230 can be configured on any device, with respect to any operating system. The software 230 can be access through an ‘app store’ or via a landing page. The user interface of the software 230 overcomes any technical shortcomings of conventional social media applications/tools (e.g., linear feed with continuous scrolling and/or swiping; binary/static user information; overwhelming providing of user causing nervousness) by at least introducing a set of features and information to a new user. Once the new user becomes experienced, the software 230 can provide additional information and additional features.

At block 370, the software 230 analyzes the current profile with respect to other user profiles. A shown by way of example, the block 370 of the method 300 includes sub-blocks 373 and 377. At sub-block 373, the software 230 analyzes one or more digital files of one or more user profiles and a current user profile to generate proximity data, affinity data, or authenticity data. At sub-block 377, the software 230 determines one or more matches between the one or more user profiles and the current user profile based on the proximity data, the affinity data, or the authenticity data. The one or more matches suggest high value and meaningful connections between the one or more user profiles and the current user profile.

According to one or more embodiments, the software 230 can be configured to analyze factors for matching, such as proximity (e.g., time and space) over distance, recency over stale, premium status (e.g., a bump in the score, interests with respect to quantity vs. quality, interests with respect to personal vs public, etc. In this regard, the software 230 implementing the method 300 can be considered a social media application designed to digitally scale the ability to organically forge high value and meaningful human connections. The software 230 recognizes and overcomes that conventional social media applications/tools of social landscapes have failed to successfully integrate some of the most powerful psychological bases (e.g., proximity, affinity, and authenticity) rooted in the human experience that drives human connection. The software 230 provides a formulated technical interface as a simple, fun interface, to harness proximity, affinity, and authenticity to infinitely scale human connections (for whatever purpose users find value in). As noted herein, purposes of a user may include, but are not limited to, people watching of strangers as casual observers, forging new connections, establishing friendships, dating, and/or networking.

For example, regarding proximity, the software 230 can be configured to utilize academic and professional peer reviewed psychological studies to leverage that humans are more likely to favorably view and forge bonds with others as a consequence of being in closer physical proximity with each other. By contrast, when conventional social media applications/tools reduce the importance of proximity, humans feel great angst and experience negative psychological, mental, and emotional consequences. Thus, proximity data can include a close physical immediacy by correlating a time and a space of the two profiles (e.g., “here and now” or “right here, right now”). The digital NFT asset 237 can provide proximity data by validating attendance (e.g., actual presence). For instance, two users attend the same concert. Further, proximity data can include time thresholds, where attendance is measure based on arrival, how long, and departure metrics. Two users may have attended the same marathon, however, if they attended at different times of the day, then they may not be considered proximate. Furthermore, proximate data can include dimensional data (e.g., x, y, z coordinates). In this regard, two users may have been in the same venue for a concert, however, if one user was in the front row and another user was in a sky box (e.g., separated by a 6 story vertical), then they may not be considered proximate. Additionally, if a user is in a coffee shop with another user, then the users are proximate. In this way, a confluence of time and space result with in the user being proximate (e.g., in “Fishbowl” or “In the room” together). As soon one of users leave, then the users are distant (e.g., which means they are “The Sea” respectively or “Out there”, and correspondingly removed from each other's “Fishbowl” or “In the room”).

Further, regarding affinity, the software 230 can be configured to leverage that humans find value and comfort in connections with each other when affinity is shared. This may come in the form of common or similar interests, viewpoints, proclivities, attitudes, philosophies, tastes, hobbies, opinions, or experiences (affinity is determinable but also controllable, by virtue of the public and personal manner of input of interests). The greater the quantity and/or the quality of these shared affinities, the more likely, more valuable, and more intense the connection is likely to be. Thus, affinity data can include likes, values, and comforts. The digital NFT assets 237 can provide affinity data by validating and/or supporting likes, values, and comforts (e.g., admiration for dogs). Two users annually attend the same dog show and have a collection of digital NFT assets 237 validating this admiration can be matched accordingly.

Further, regarding authenticity, the software 230 can be configured to leverage the notion that being authentic is a third glue of human connections. When people share their authentic nature with each other, as opposed to a more manicured, generalized, public facing version of themselves, deeper connections are more likely to be formed, especially/at least when those authentic characteristics are shared, welcomed, or well received. When humans feel that they are experiencing a fake, concealing, or contrived version of each other, intimate, high value connections wane. Humans are not static, one-dimensional entities, whereby a public profile may vividly capture their essence as a means to connect with others via their respective public profiles. Instead, humans are multi-layered, complex, dynamic beings, who find favor, feel, conceal, and reveal various aspects of themselves for a myriad of reasons and motivations. When an individual voluntarily divulges a deeper, more hidden or secretive layer of themselves to another, the other individual is more likely to recognize and appreciate that authenticity, and reward that expression with a sliver of their authentic self in turn. As a result, it is also more likely for a chain effect to be set in motion, whereby more meaningful and more authentic, inward traits are mutually revealed, thus nourishing and deepening the bond between those two individuals (authenticity can be fostered by linking people with others who truly share traits and interests and they are able to divulge more personal layers of themselves). The appreciation of realizing the other's vulnerability by sharing this information furthers this glue, and trust is more likely to be fashioned. Thus, authenticity data can include verified activity and/or assertions. The digital NFT assets 237 can provide authenticity data by validating a participation (e.g., in breast cancer charity run), as described herein (the authenticity data is derived from at the digital NFT assets 237).

According to one or more embodiments, one or more technical effects, advantages, and/or benefits of the software 230 include fostering authenticity by integrating the digital NFT assets 237. The possession of a digital NFT asset 237 indicates that a person received and/or purchased a particular digital file and does not possess the digital file by accident. In turn, a façade of possession is impossible and Subterfuge is far less likely as a person has to ‘put their money where their mouth is’, rather than simply stating that a person likes marathons. In this way, a display of one digital NFT asset 237 vs. twenty digital NFT assets 237 corresponding to marathons conveys far more accurately an extent and significance of marathon running in a person's life. Further, users may more aptly conclude traits and characteristics of other individuals from the digital NFT assets 237 possession than photos (which can be far more contrived, faked, or doctored) or stated hobbies/interests. The ‘trust’ in the veracity of the NFT itself as well as its linkage to the digital file and the owner is far less in dispute, which eliminates ‘catfishing’ or profile manipulation that more commonly exists in the conventional social media applications/tools (manicured highlight reels that have come to be associated with social media can now be authenticated by an accurate scrapbook/wallet display of the digital NFT asset 237 collected through the years). Thus, posts with validating digital NFT assets 237 tell the story, creating an authentic feed and giving priority to filtering/searching (e.g., each digital NFT assets 237 raises an authenticity of a user profile).

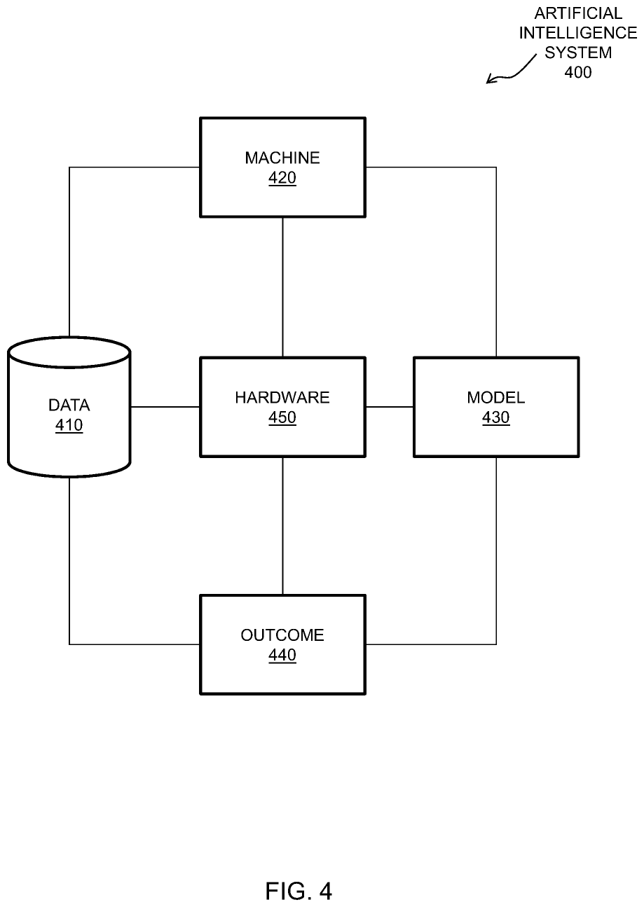

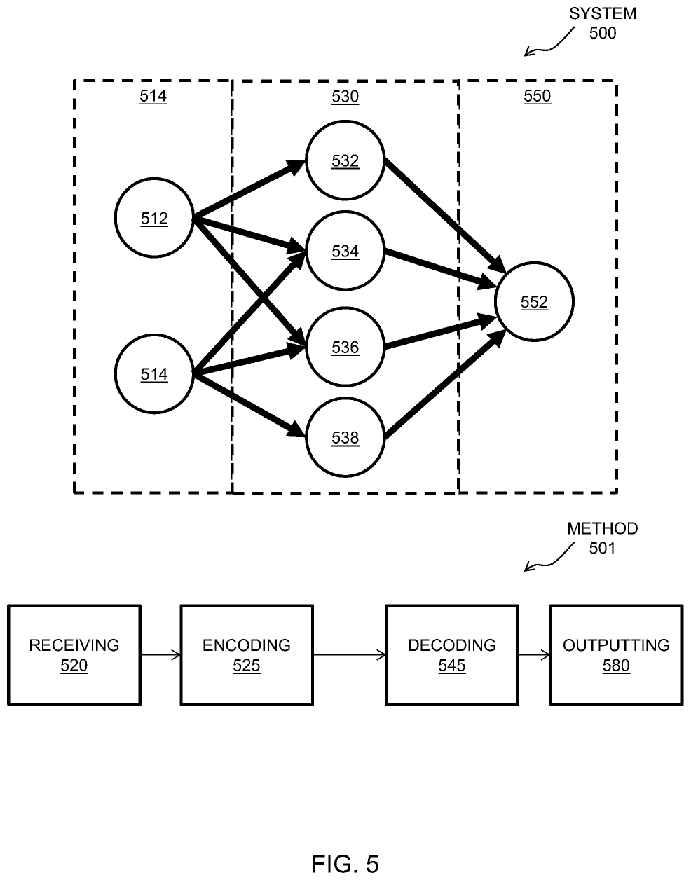

The technical effects and benefits of the method 300 include enabling harnessing these aspect of proximity, affinity, and authenticity through digital manipulation of user inputs, automatic scores, weights, etc. According to one or more embodiments, the software 230 utilizes ML/AI algorithm module therein, as described with respect to FIGS. 4-5.

FIG. 4 illustrates a graphical depiction of an artificial intelligence system 400 according to one or more embodiments. The artificial intelligence system 400 includes data 410, a machine 420, a model 430, an outcome 440, and (underlying) hardware 450. The description of FIGS. 4-5 is made with reference to FIGS. 1-3 for ease of understanding where appropriate. For example, the machine 420, the model 430, and the hardware 450 can represent aspects of the software 230 of FIG. 2 (e.g., ML/AI algorithm module therein), while the hardware 450 can also represent the device 205 of FIG. 2. In general, the machine learning and/or the artificial intelligence algorithms of the artificial intelligence system 400 (e.g., as implemented by the software 230 of FIG. 2) operate with respect to the hardware 450, using the data 410, to train the machine 420, build the model 430, and predict the outcomes 440.

For instance, the machine 420 operates as the controller or data collection associated with the hardware 450 and/or is associated therewith. The data 410 can be on-going data or output data associated with the hardware 450. The data 410 can also include currently collected data, historical data, or other data from the hardware 450 and can be related to the hardware 450. The data 410 can be divided by the machine 420 into one or more subsets. As an example, the data 410 can be one or more user profiles and information associated therewith (e.g., the proximity data, the affinity data, and the authenticity data of the psychological and experienced based user information).

Further, the machine 420 trains, such as with respect to the hardware 450. This training can also include an analysis and correlation of the data 410 collected. In accordance with another embodiment, training the machine 420 can include self-training by the software 230 of FIG. 2 utilizing the one or more subsets. In this regard, the software 230 of FIG. 2 learns to detect profile connections, proximity information, and/or heat meter information.

Moreover, the model 430 is built on the data 410 associated with the hardware 450. Building the model 430 can include physical hardware or software modeling, algorithmic modeling, and/or the like that seeks to represent the data 410 (or subsets thereof) that has been collected and trained. In some aspects, building of the model 430 is part of self-training operations by the machine 420. The model 430 can be configured to model the operation of hardware 450 and model the data 410 collected from the hardware 450 to predict the outcome 440 achieved by the hardware 450. Predicting the outcomes 440 (of the model 430 associated with the hardware 450) can utilize a trained model 430. Thus, using the outcome 440 that is predicted, the machine 420, the model 430, and the hardware 450 can be configured accordingly.

Thus, for the artificial intelligence system 400 to operate with respect to the hardware 450, using the data 410, to train the machine 420, build the model 430, and predict the outcomes 440, the machine learning and/or the artificial intelligence algorithms therein can include neural networks. In general, a neural network is a network or circuit of neurons, or in a modern sense, an artificial neural network (ANN), composed of artificial neurons or nodes or cells.

For example, an ANN involves a network of processing elements (artificial neurons) which can exhibit complex global behavior, determined by the connections between the processing elements and element parameters. These connections of the network or circuit of neurons are modeled as weights. A positive weight reflects an excitatory connection, while negative values mean inhibitory connections. Inputs are modified by a weight and summed using a linear combination. An activation function may control the amplitude of the output. For example, an acceptable range of output is usually between 0 and 1, or it could be −1 and 1. In most cases, the ANN is an adaptive system that changes its structure based on external or internal information that flows through the network.

In more practical terms, neural networks are non-linear statistical data modeling or decision-making tools that can be used to model complex relationships between inputs and outputs or to find patterns in data. Thus, ANNs may be used for predictive modeling and adaptive control applications, while being trained via a dataset. Note that self-learning resulting from experience can occur within ANNs, which can derive conclusions from a complex and seemingly unrelated set of information. The utility of artificial neural network models lies in the fact that they can be used to infer a function from observations and also to use it. Unsupervised neural networks can also be used to learn representations of the input that capture the salient characteristics of the input distribution, and more recently, deep learning algorithms, which can implicitly learn the distribution function of the observed data. Learning in neural networks is particularly useful in applications where the complexity of the data or task makes the design of such functions by hand impractical.

Neural networks can be used in different fields. Thus, for the artificial intelligence system 400, the machine learning and/or the artificial intelligence algorithms therein can include neural networks that are divided generally according to tasks to which they are applied. These divisions tend to fall within the following categories: regression analysis (e.g., function approximation) including time series prediction and modeling; classification including pattern and sequence recognition; novelty detection and sequential decision making; data processing including filtering; clustering; blind signal separation, and compression. For example, application areas of ANNs include non-linear system identification and control (vehicle control, process control), game-playing and decision making (backgammon, chess, racing), pattern recognition (radar systems, face identification, object recognition), sequence recognition (gesture, speech, handwritten text recognition), financial applications, data mining (or knowledge discovery in databases, “KDD”), visualization and e-mail spam filtering.

According to one or more embodiments, the neural network can implement a long short-term memory neural network architecture, a convolutional neural network (CNN) architecture, or other the like. The neural network can be configurable with respect to a number of layers, a number of connections (e.g., encoder/decoder connections), a regularization technique (e.g., dropout); and an optimization feature.

The long short-term memory neural network architecture includes feedback connections and can process single data points (e.g., such as images), along with entire sequences of data (e.g., such as speech or video). A unit of the long short-term memory neural network architecture can be composed of a cell, an input gate, an output gate, and a forget gate, where the cell remembers values over arbitrary time intervals and the gates regulate a flow of information into and out of the cell.

The CNN architecture is a shared-weight architecture with translation invariance characteristics where each neuron in one layer is connected to all neurons in the next layer. The regularization technique of the CNN architecture can take advantage of the hierarchical pattern in data and assemble more complex patterns using smaller and simpler patterns. If the neural network implements the CNN architecture, other configurable aspects of the architecture can include a number of filters at each stage, kernel size, a number of kernels per layer.

Turning now to FIG. 5, an example of a neural network 500 and a block diagram of a method 501 performed in the neural network 500 are shown according to one or more embodiments. The neural network 500 operates to support implementation of the machine learning and/or the artificial intelligence algorithms (e.g., as implemented by the software 230 of FIG. 2) described herein. The neural network 500 can be implemented in hardware, such as the machine 420 and/or the hardware 450 of FIG. 4. As indicated herein, the description of FIGS. 4-5 is made with reference to FIGS. 1-3 for ease of understanding where appropriate.

In an example operation, the software 230 of FIG. 2 includes collecting the data 410 from the hardware 450. In the neural network 500, an input layer 510 is represented by a plurality of inputs (e.g., inputs 512 and 514 of FIG. 5). With respect to block 520 of the method 501, the input layer 510 receives the inputs 512 and 514.

At block 525 of the method 501, the neural network 500 encodes the inputs 512 and 514 utilizing any portion of the data 410 (e.g., the dataset and predictions produced by the artificial intelligence system 400) to produce a latent representation or data coding. The latent representation includes one or more intermediary data representations derived from the plurality of inputs. According to one or more embodiments, the latent representation is generated by an element-wise activation function (e.g., a sigmoid function or a rectified linear unit) of the software 230 of FIG. 2. As shown in FIG. 5, the inputs 512 and 514 are provided to a hidden layer 530 depicted as including nodes 532, 534, 536, and 538. The neural network 500 performs the processing via the hidden layer 530 of the nodes 532, 534, 536, and 538 to exhibit complex global behavior, determined by the connections between the processing elements and element parameters. Thus, the transition between layers 510 and 530 can be considered an encoder stage that takes the inputs 512 and 514 and transfers it to a deep neural network (within layer 530) to learn some smaller representation of the input (e.g., a resulting the latent representation).

The deep neural network can be a CNN, a long short-term memory neural network, a fully connected neural network, or combination thereof. This encoding provides a dimensionality reduction of the inputs 512 and 514. Dimensionality reduction is a process of reducing the number of random variables (of the inputs 512 and 514) under consideration by obtaining a set of principal variables. For instance, dimensionality reduction can be a feature extraction that transforms data (e.g., the inputs 512 and 514) from a high-dimensional space (e.g., more than 10 dimensions) to a lower-dimensional space (e.g., 2-3 dimensions). The technical effects and benefits of dimensionality reduction include reducing time and storage space requirements for the data 410, improving visualization of the data 410, and improving parameter interpretation for machine learning. This data transformation can be linear or nonlinear. The operations of receiving (block 520) and encoding (block 525) can be considered a data preparation portion of the multi-step data manipulation by the software 230.

At block 545 of the method 510, the neural network 500 decodes the latent representation. The decoding stage takes the encoder output (e.g., the resulting the latent representation) and attempts to reconstruct some form of the inputs 512 and 514 using another deep neural network. In this regard, the nodes 532, 534, 536, and 538 are combined to produce in the output layer 550 an output 552, as shown in block 560 of the method 510. That is, the output layer 590 reconstructs the inputs 512 and 514 on a reduced dimension but without the signal interferences, signal artifacts, and signal noise.

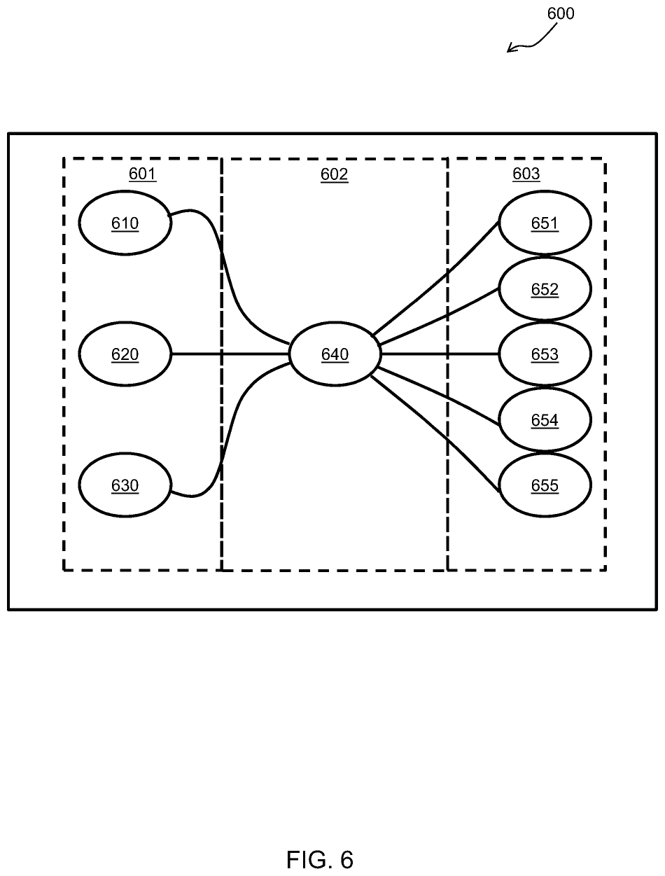

Returning to FIG. 3, the method 300 continues at block 385, where the software 230 engages a user to provide profile connections (e.g., presents a user interface in accordance with the one or more matches or the proximity data, affinity data, or authenticity data). In this regard, reference is may to FIGS. 6-18, which illustrate one or more exemplary diagrams and interfaces according to one or more exemplary embodiments. As shown in diagram 600 of FIG. 6, the software 230 can provide a plurality of features to generate profile connections.

Generally, as shown by the diagram 600 of FIG. 6, the software 230 generates profile connections to revolutionize human connections across a framework of psychology 601, technology 602, and infinite scale 603. In diagram 600, the framework of the software 230 implements a continuous arc through the technology 602 to provide human connections based on the psychology 601 and the infinite scale 603 (e.g., the software 230 can be a framework designed to take users seamlessly through a continuous arc of emotions necessary for human connection making and through a consolidated, simple, user friendly interface). In this regard, the psychology 601 of proximity data 610, affinity data 620, and authenticity data 630 are utilized by the technology 602 (i.e., the software 230 implementing the method discussed herein) across the infinite scale 603 of different types of connections. The connection types include, but are not limited to, strangers and casual connections 651, new connections 652, friends 653, dating 654, and networking 655.

For example, with respect to psychology 601, the digital files 236 and the digital NFT assets 237 can be utilized to show and verify proximity (e.g., using the proximity data 610) based on real time purchases of or acquisitions, as well as time stamps (e.g., information associated with a digital audio file associated with an NFT verifies physical real time presence at a concert). Further, the digital files 236 and the digital NFT assets 237 can be utilized to show and verify affinity(e.g., using the affinity data 620) based ownership (e.g., information associated with an image file associated with an NFT purchased at a muscle car convention verifies a user's likes, values, etc. muscle cars). Furthermore, the digital files 236 and the digital NFT assets 237 can be utilized to show and verify authenticity (e.g., using the authenticity data 630) based real time ownership (e.g., information associated with an ticketing file associated with an NFT purchased to participate in a breast cancer charity run authenticates a user's attendance).

According to one or more embodiments, the digital files 236 and the digital NFT assets 237 can be leveraged by the software within the pinwheel view of nearby neighbors (e.g., proximity matching), for automatic matching of personal interests (e.g., affinity matching), for verifying inner thoughts and interests (e.g., providing authenticity), etc. Thus, operations and actions within and by the software 230 minimize or potentially even eliminate certain social, psychological, and emotional risks that may otherwise typically exist.

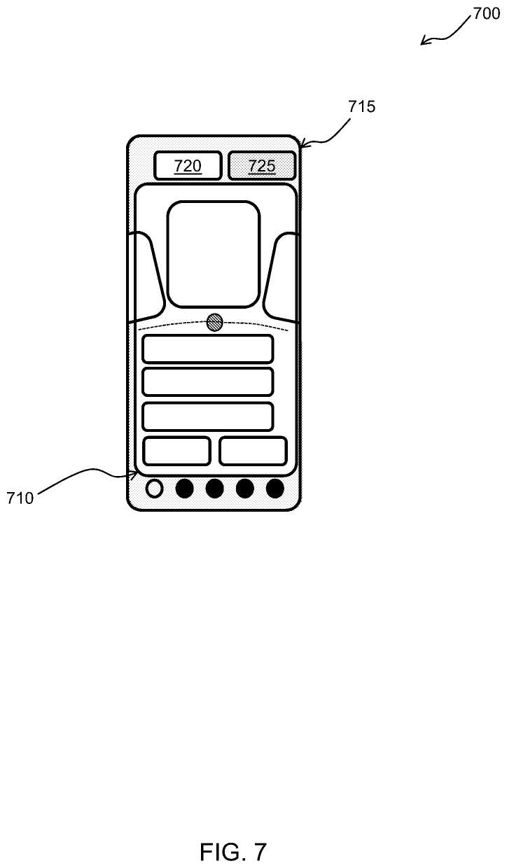

As shown in interface 700 of FIG. 7, the software 230 can provide a pinwheel view of users, including a nearby mode (e.g., proximate view and distant view). According to one or more embodiments, the user interface 700 presents users with a pinwheel, free scrolling view of other users, so they may browse, a.k.a. ‘people watch’ other users. User profiles are arranged in the backend in a circular arrangement, so that a left or right finger swipe on the lead, central profile photo creates a clockwise or counterclockwise scroll through the profiles. As the picture profiles (e.g., the digital files 236 and/or the digital NFT assets 237) scroll through the central frame, contained within the viewing screen 710 of the phone 715, accompanying profile information/ingredients similarly track and appear. The users eventually connect in an aggregated circle, digitally existing in the backend, but visually, only the main one in central frame appears somewhat larger, while the neighboring profiles to the left and right of the central profile appear partially in view, and somewhat smaller. Pinwheel browsing can provide dynamic/organic constant feedback, where profiles are adaptively presented based on the viewer. Example operations of the pinwheel (e.g., a specialized a browsing window) include wheeling/scrolling and expanding and collapsing profiles. The software can determine who the viewer browses and who they are most likely to come back to. Note that the viewer can switch views between proximate 720 and distant 725. The software 230 can define (e.g., algorithm defined) the proximate/fishbowl, while the distant/sea can be everyone and then filtered. AR/VR can be applied by the software 230 such that an adaptive design where the viewer can see different sides of people is presented. Thus, the software 230 can squeeze a diverse tapestry of human experience in different pictures (e.g., infuse the tapestry of human internet rather than binary presentation) and digitize the organic-ness of human connections (A to B is different than A to C).

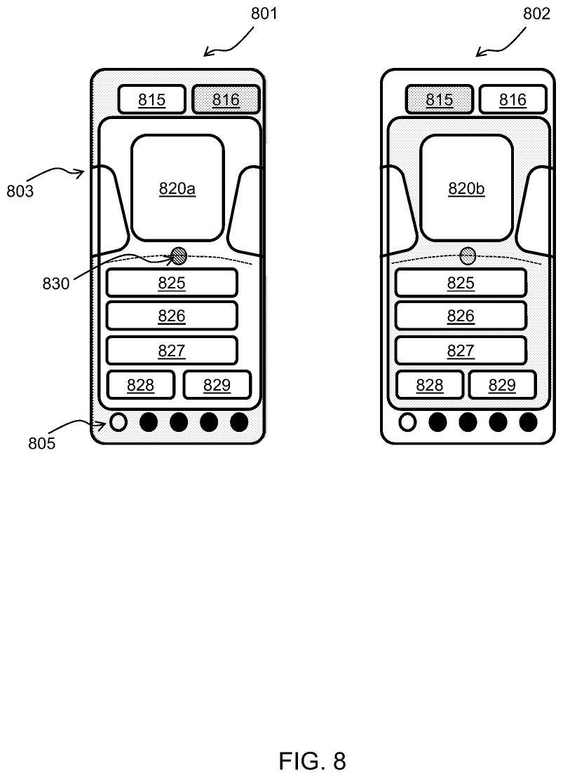

Turning to FIG. 8, interfaces 801 and 802 are shown according to one or more exemplary embodiments. As shown in FIG. 2, the software 230 can provide a menu bar 805 where a first selectable icon can be a search menu. Upon selection of the search menu, the software 230 can provide a pinwheel view 803 of users. The pinwheel view 803 of users can be manipulated according to at least two viewing zones, such as a selectable proximate view 815 and a selectable distant view 816 (e.g., “Fishbowl” and “The Sea” respectively or “In the room” and “Out there”). The proximate view 815 enables users to view profiles of users close by them. Using a combination of hyper-specific GPS technology in smartphones and a controlled radius setting, users see other users in that defined radius. This radius can be initially set along a range of distance (e.g., as 1000 feet or 300 yards, essentially a football field or city block), and can be pared down as the user population grows. The unique feature of the proximate view 815 is that users can digitally people watch who is around and nearby them, seeing their profile photos (e.g., a picture or a digital NFT asset), name/nickname, age if displayed publicly, digital NFT assets, and interests. According to one or more embodiments, the software 230 can implement one or more algorithms as described herein for the one or more views (e.g., filtering the user profiles based on a proximity setting of a current user profile to provide a filtered profile set). For example, in the proximate view 815, users see and browse everyone in that set radius, nearby them. As the user population grows, filters may be embedded in future releases in the proximate viewing zone. In the distant view 816, users may control who they see by filtering for radius, gender and age preferences, and interests.

According to one or more embodiments, the pinwheel view 803 presents users with a pinwheel, free scrolling view of other users, so a current user may browse, a.k.a. ‘people watch’ other users. The one or more profile connections are arranged in the backend in a circular arrangement, so that a left or right finger motion on a lead, central profile creates a clockwise or counterclockwise scroll through the profiles. As the profiles (e.g., the digital files 236 and/or the digital NFT assets 237) scroll through the central frame, contained within a viewing screen of a phone, accompanying profile information/ingredients similarly track and appear. That, as each profile of the pinwheel settles into a center of the interface 801 or 802, additional information is provided by the software 230. According to one or more embodiments with respect to pinwheel browsing via the pinwheel view 803 of users, the users eventually connect in an aggregated circle, digitally existing in the backend, but visually, only the main one in central frame appears somewhat larger, while the neighboring profiles to the left and right of the central profile appear partially in view, and somewhat smaller. Pinwheel browsing can provide dynamic/organic constant feedback, where profiles are adaptively presented based on the viewer. Example operations of the pinwheel (e.g., a specialized a browsing window) include wheeling/scrolling and expanding and collapsing profiles. The software can determine who the viewer browses and who they are most likely to come back to. Note that the viewer can switch views between proximate 815 and distant 816. The software 230 can define (e.g., algorithm defined) the proximate/fishbowl, while the distant/sea can be everyone and then filtered. AR/VR can be applied by the software 230 such that an adaptive design where the viewer can see different sides of people is presented. Thus, the software 230 can squeeze a diverse tapestry of human experience in different pictures (e.g., infuse the tapestry of human internet rather than binary presentation) and digitize the organic-ness of human connections (A to B is different than A to C). According to one or more embodiments, the digital files 236 and the digital NFT assets 237 can be leveraged by the software within the pinwheel view of nearby neighbors (e.g., proximity matching), for automatic matching of personal interests (e.g., affinity matching), for verifying inner thoughts and interests (e.g., providing authenticity), etc. Thus, operations and actions within and by the software 230 minimize or potentially even eliminate certain social, psychological, and emotional risks that may otherwise typically exist.

As shown in FIG. 8, each profile presents a picture 820 (e.g., picture profiles, the digital files 236, and/or the digital NFT assets 237), identifying information 825 (e.g., name, age, etc.), public interests 826, private interests 827, first hello 828, second hello 829, and heat meter 830. The public interests 826 show information about a profile that are readily discoverable. The private interests 827 show information about a profile that are discoverable based on a high value and meaningful match. The first hello 828 can be considered a bold introduction, and the second hello 829 can be considered a shy introduction. Not that aspects of the “Bold/Shy” introductions can be labeled or implemented using alternative nomenclature and/or shorthand images, such as “Chat now” and “Let's see,” respectively. According to one or more embodiments, once a user has viewed the profile of another user and has the desire to try to establish a conversation or connection, he/she may do so by one or more methods. For example, a method includes sending a “Bold Hi”, by selecting the first hello 828, that drives the sending user's “Bold Hi” right to the receiving user's inbound notification area and initiates a chat. Another method includes sending a “Shy Hi”, by selecting the second hello 829 that sends the initiating user's “Shy Hi” to the receiving user's inbound notification area, but does not notify the receiving users as to the identity of the sending user. Instead, the receiving user now knows that some other user has sent them a shy hello, but they have no idea who sent it. The only way to find out is to reciprocate by sending shy HI's in similar fashion. Once the two individuals successfully have “Shy Hi'd” each other, the software 230 pairs these hello's, provides a celebratory splash notice screen, and provides the natural next action suggestion by way of clicking on a continue button to initiate a chat.

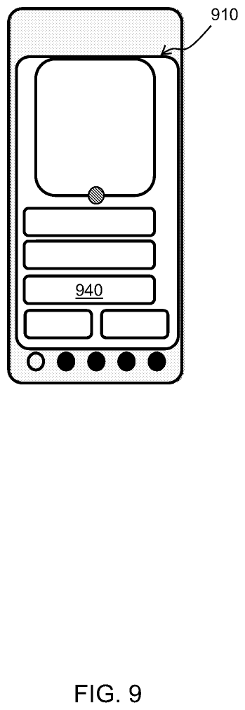

As shown in an interface 910 of FIG. 9, the software 230 can provide personal interests and automatic matching thereof. For instance, the software 230 provides usage, display, and notification of personal interests (e.g., also known as “private Interests”, which is in contrast to “public interests”). Users may populate their profiles with individually user fed personal interests, which are only visible to other users if those users share the same interest.

For example, in the interface 910, if User 1 has “Coffee” as a personal interest that is authenticated with a digital NFT asset 940, User 2 will only see this interest on User 1's profile if User 2 has “Coffee” authenticated somewhere in his/her profile's interests list (either publicly or privately).

For example, if User A has “Space Research” as a personal interest, User B will only see this interest on User A's profile if User B has “Space Research” somewhere in his/her profile's interests list (either publicly or privately). Vice versa, User A would see “Space Research” on User B's profile because User A shares this interest. The rest of the population of users would not see “Space Research” on either User A's or User B's profiles, unless of course such other user shared the same interest. Users public interests, by contrast, are visible in all relevant search views where their profile would appear.

For all interests, users input them at the time of initial sign up and onboarding during profile creation, and have the ability to add to, delete, and edit their interests in their profile settings. The software 230 compiles all these users, their interests, and their corresponding parameters (public or personal) as data points, and matches and reveals them to users per the above logic. In addition, users may opt to permit notifications in their settings, which then causes the software 230 to notify via push notifications or other user chosen methods, the users if other users who share relevant interests (designated by the primary user in question) to them. That is, User A may set up his/her notifications preferences for the software 230 to notify him/her if another user who is interested in “Space Research” is in proximate mode distance. Thus, users may dial specifically into what they are seeking on a more personal level, or even be notified when they are not actively engaged in using the software 230. Users see public interests highlighted in a more prominent color when they are held in common with the user they are viewing, so as to stand out and be noticed. In accordance with one or more embodiments, notifications can accommodate notifying when a User B is nearby to User A (e.g., respective to a certain distance threshold) and/or has the same specified interests as User A.

According to one or more embodiments, the software 230 can deploy additional manual safeguards, whereby a User's personal interests won't be automatically made known to other users (even matching interested users), but rather only the fact that they share a personal interest will, and then the user will have the option to unlock the content of that specific personal interest. According to one or more embodiments, a user can selectively reveal, conceal, and/or re-conceal or -reveal personal interests/inner thoughts.

According to one or more embodiments, features of the software 230 are not designed to operate in isolation. The software 230 is synergized into the continuous user arc, taking random strangers from people watching, through connecting, chatting, sharing their interest in each other, and sharing more intimate details about themselves with one another. The entire time, the software 230 is able to do so from a psychological, emotional, and mental place of security, to enable user to be able to pursue interests, various types of relationships with individuals, and convey their intentions accordingly. The software 230 is organic, spontaneous, rewarding, mutually enriching and satisfying, while minimizing stigma, risk, and fear of rejection. Comprised of multiple unique and features, the software 230 provides an overall experience fusing the features described herein together, while itself being an independently psychologically and technologically unique design.

According to one or more embodiments, the software 230 achieves a goal of a cross-versatile experience where user's post, view, comment, interact, etc. with each other's a profile feed, which can include at least digital NFT assets 237. Generally, authenticity is an attractive phenomena that fosters trust and therefore permits better quality profile connections. When users ‘feel’ that they are seeing and experiencing real traits of another, more genuine qualities, and especially qualities that are perhaps not openly known to the rest of the world, these users are more likely to reveal similar traits (e.g., in turn, offer up a more authentic/genuine version of themselves and forge bonds that are cyclically more authentic, deep, and meaningful). The ability to differentiate authenticity from posing or posturing (or even outright lying) is implemented through the blockchain as described herein.

The software 230 implements this leveraging by relying on psychological and experienced based user information (from proximity, affinity, and authenticity data), as well as sources and trustworthiness of the user information. Consciously, strategically, subconsciously, and/or out of various forms of desire, users put forth information about themselves to the world in various forms that establish indicia for others' views of them and establish a bases for on-ramps to interactions. These interactions may range from distant observation, closer observation, limited interaction, or more in depth interaction. Items and tokens that users wear, possess, display, or otherwise manifest, convey representation of themselves, which they may embrace or unwittingly convey. For example, the extravagance of clothes, jewelry, cars; the content, brand or style associated thereof; and the explicit or implicit assumptions conveyed thereof, all affect human connections. Other examples include bumper stickers, stickers placed on laptops, and tattoos. An individual's t-shirt design may communicate preferred sports teams, places visited, political ideologies, attitudes about life and culture, and more. Watches, cars, and brand name fashion choices are customarily displayed to communicate wealth, status, power, or even the exaggerated quality thereof. Depending on the user, the setting, the users associated that use, the user inclination, or even a temporary mood, users may choose to communicate by displaying tokens in an outwardly public manner, a subtle personal manner, or a private manner. For example, a user may choose to wear an expensive watch to a business meeting when status is important for deal making, while the same user may choose to wear a less expensive watch when on vacation to keep a lower profile. Note that it can be common for users, especially when aided by these display tokens, to notice each other, form conclusions or assumptions based on the tokens, form desires to interact based on tokens, feel a shared common ground based on the tokens, initiate contact based on the tokens, or scale or deepen their connection based on the tokens. For example, users may feel socio-economically situated by like brands or jewelry, with having visited a same vacation site observed on bumper sticker, sharing a favorite sport, team, or culture (all derived from the tokens). The software 230 utilizes the digital NFT assets 237 to extend these observations and connections to the digital world. In this way, the software 230 solves current problems where the digital world is not associated with proximity despite geographic selectors (i.e., zip code, city, region, or more narrowly, within a certain radius of oneself in miles). Current social media applications/tools, while using linked datapoints have yet to solve how to implement the immediacy of time and proximity.

Similarly, while a thirst by users for authenticity has not waned, users are limited in how they represent and brand themselves by conventional social media applications/tools. For instance, users may wonder if a car behind a user in a picture on a social platform is really owned by the user, or just photographed as a passerby experience in a parking lot. Further, a user may see another use post pictures at a certain event that was an isolated attendance and does not truly reflect another user's inclinations. The software 230 solves the problems of whether pictures are recent, are reflective, are filtered, etc. because the software 230 animates proximity (e.g., immediacy), affinity, and authenticity principles through at least the digital NFT assets 237. As users reveal more about themselves, both automatically through auto display of matching public and personal interests, and manually through selectively revealing other personal interests and their inner thoughts, the proximity (e.g., immediacy), affinity, and authenticity principles by the software 230 are imbued in the profile connection process. For instance, integration of the digital NFT assets 237 by the software 230 into the viewing and connection interfaces furthers psychological and connective goals and phenomena for users. By no longer relying on manual alpha-numerical input (i.e., typing in their interests) or self-selected photographs/videos for display, the software 230 integrates the display of the digital NFT assets 237 from NFT wallets, as well as preserves choices and selectivity. The software 230 enables users to choose to display of public digital NFT assets 237 and/or personal digital NFT assets 237 with typed and stated interests. Other users are then able to see and act based upon the digital NFT assets 237.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. A computer readable medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire

Examples of computer-readable media include electrical signals (transmitted over wired or wireless connections) and computer-readable storage media. Examples of computer-readable storage media include, but are not limited to, a register, cache memory, semiconductor memory devices, magnetic media such as internal hard disks and removable disks, magneto-optical media, optical media such as compact disks (CD) and digital versatile disks (DVDs), a random access memory (RAM), a read-only memory (ROM), an erasable programmable read-only memory (EPROM or Flash memory), a static random access memory (SRAM), and a memory stick. A processor in association with software may be used to implement a radio frequency transceiver for use in a terminal, base station, or any host computer.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The descriptions of the various embodiments herein have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
analyzing, by a software platform and interface executed by one or more processors, one or more digital files of one or more user profiles and a current user profile to generate proximity data, affinity data, or authenticity data;
determining, by the software platform and interface, one or more matches between the one or more user profiles and the current user profile based on the proximity data, the affinity data, or the authenticity data; and
presenting, by the software platform and interface, a user interface in accordance with the one or more matches or the proximity data, affinity data, or authenticity data.

2. The method of claim 1, further comprising:
filtering the one or more user profiles based on a proximity setting of a current user profile to provide a filtered profile set including one or more filtered profiles.

3. The method of claim 2, wherein the proximity setting comprises time and space factors.

4. The method of claim 1, wherein the software platform and interface provides a pinwheel user interface for the one or more matches.

5. The method of claim 1, wherein the one or more matches suggest high value and meaningful connections between the one or more user profiles and the current user profile.

6. The method of claim 1, wherein one of the one or more digital files is associated with a non-fungible token (NFT) to provide a digital NFT asset.

7. The method of claim 6, wherein the authenticity data is derived by the software platform and interface from at least the digital NFT asset.

8. The method of claim 1, wherein the proximity data comprises an immediacy that correlates a time and a space confluence of the one or more user profiles and the current user profile.

9. The method of claim 1, wherein the user interface of the software platform and interface presents a profile feed for each of the one or more matches, the profile feed comprising at least one or more digital non-fungible token (NFT) assets.

10. The method of claim 1, wherein the proximity data, the affinity data, or the authenticity data provide psychological and experienced based user information for each of the one or more user profiles and the current user profile.

11. A computer program product stored on a computer readable storage medium and executable by at least one processor, the computer program product comprising:
analyzing, by a software platform and interface executed by one or more processors, one or more digital files of one or more user profiles and a current user profile to generate proximity data, affinity data, or authenticity data;
determining, by the software platform and interface, one or more matches between the one or more user profiles and the current user profile based on the proximity data, the affinity data, or the authenticity data; and
presenting, by the software platform and interface, a user interface in accordance with the one or more matches or the proximity data, affinity data, or authenticity data.

12. The computer program product of claim 11, further comprising:
filtering the one or more user profiles based on a proximity setting of a current user profile to provide a filtered profile set including one or more filtered profiles.

13. The computer program product of claim 12, wherein the proximity setting comprises time and space factors.

14. The computer program product of claim 11, wherein the software platform and interface provides a pinwheel user interface for the one or more matches.

15. The computer program product of claim 11, wherein the one or more matches suggest high value and meaningful connections between the one or more user profiles and the current user profile.

16. The computer program product of claim 11, wherein one of the one or more digital files is associated with a non-fungible token (NFT) to provide a digital NFT asset.

17. The computer program product of claim 16, wherein the authenticity data is derived by the software platform and interface from at least the digital NFT asset.

18. The computer program product of claim 11, wherein the proximity data comprises an immediacy that correlates a time and a space confluence of the one or more user profiles and the current user profile.

19. The computer program product of claim 11, wherein the user interface of the software platform and interface presents a profile feed for each of the one or more matches, the profile feed comprising at least one or more digital non-fungible token (NFT) assets.

20. The computer program product of claim 11, wherein the proximity data, the affinity data, or the authenticity data provide psychological and experienced based user information for each of the one or more user profiles and the current user profile.
